(19) United States
(12) Patent Application Publication
(10) Pub. No.: US 2025/0254090 A1
(43) Pub. Date: Aug. 7, 2025

(54) AUTONOMOUS RECONFIGURATION OF DEVICE COMPONENTS

(71) Applicant: HEWLETT PACKARD ENTERPRISE DEVELOPMENT LP, Spring, TX (US)

(72) Inventors: Pierre-Yves Descombes, Grenoble (FR); Biswadeb Dutta, Chestbut Hill, MA (US); Madhushree Gubbi Chikkanna, Bangalore (IN)

(21) Appl. No.: 18/736,756

(22) Filed: Jun. 7, 2024

(30) Foreign Application Priority Data
Feb. 2, 2024 (EP) 24305187.7

(51) Int. Cl. H04L 41/0833; G16Y 20/30; H04L 41/16

(52) U.S. Cl. CPC H04L 41/0833; H04L 41/16; G16Y 20/30

(57) ABSTRACT

Systems and methods are provided for continuously identifying IoT devices that are operating at non-optimal configurations and reconfiguring those devices using adjustments to the IoT device configuration settings. The incremental reconfiguration of the IoT devices may be adjusted using adjustment values that are determined using a machine learning (ML) model, like reinforcement learning, to maximize a reward function that predicts an increased battery lifetime for the device, among other objectives/rewards. The agent, through the machine learning process, may determine a next/second adjustment value to try to maximize cumulative rewards over time. Over a sequence of interactions of the agent/reconfiguration system with the IoT device, the high-level objective will be to observe a decreasing trend in the energy consumption, which in turn corresponds to an improving, or increasing, trend in the battery lifetime.

### BACKGROUND

Internet of Things (IoT) devices enable gathering, processing, and exchanging of data across an application/IoT platform. For example, IoT devices may be sensors, surveillance equipment, or any other smart devices being embedded in a computing system that enables these smart devices to gather, connect, and exchange data over a network. In some examples, massive IoT (M-IoT) communication systems, such as Fifth Generation (5G) communication systems, are implemented to allow M-IoT devices to communicate with a network using simplified communication protocols or protocols adapted to reduce the processing power available for a particular IoT device. Moreover, M-IoT devices may use small capacity power sources and their consumption may vary depending on the rate of recurrence of communication and network usage by IoT devices.

In these massive IoT environments, the IoT devices may be implemented as smart watering meters, smart sensors, and smart controllers for a broad range of uses. Using IoT devices, the system can measure and control other devices in the environment or access/monitor hard to reach locations. For example, when the IoT devices are water meters, the IoT devices may detect and adjust the amount of water that is distributed in an area, and can potentially alert an administrative user of leaks. When the IoT devices are in a densely-populated area, the IoT devices may be buried underground to save space and difficult to access. In other examples, the IoT devices can be implemented by the millions to assist with telecommunications technology. The IoT devices may be implemented in an area(s) with a large density of devices, such as a million IoT devices per kilometer square.

### BRIEF DESCRIPTION OF THE DRAWINGS

The present disclosure, in accordance with one or more various examples, is described in detail with reference to the following figures. The figures are provided for purposes of illustration only and merely depict examples.

FIG. 1 illustrates an example network environment that is used for optimization of power consumption of Massive-IoT devices, in accordance with the present disclosure.

FIG. 2 illustrates a schematic representation of a discovery phase and reconfiguration phase corresponding to a method of optimizing operational parameters of IoT devices, according to various examples of the present disclosure.

FIG. 3 illustrates a schematic representation of a discovery phase, according to various examples of the present disclosure.

FIG. 4 illustrates a schematic representation of an identification and reconfiguration phase of M-IoT devices, according to various examples of the present disclosure.

FIG. 5 illustrates a schematic view of a graph depicting three clusters of IoT devices, according to various examples.

FIG. 6 illustrates a flow diagram corresponding to a method for performing optimization of operational parameters of Massive-IoT devices, according to various examples of the present disclosure.

FIG. 7 is an example computing component that may be used to implement various features of examples described in the present disclosure.

FIG. 8 is an example computing component that may be used to implement various features of examples described in the present disclosure.

The figures are not exhaustive and do not limit the present disclosure to the precise form disclosed.

### DETAILED DESCRIPTION

The constrained IoT devices in traditional environments generally operate on battery power for a given duration of time. When communications with the IoT device are less effective/efficient, the battery may be consumed at a faster rate than if the IoT device were optimized to process, send, and receive the communications. This concern of inefficient communications can be compounded by the size of present communication systems. For example, with the evolution of communication systems, standards such as 5G may be capable of supporting a large number of devices (e.g., about a million devices per square kilometer) when compared to traditional communication standards, such as fourth-generation Long Term Evolution (4G-LTE). As such, while the communications with a single device may be inefficient, the operational ineffectiveness can be multiplied by the massive number of devices in the massive IoT environments alluded to above.

Additionally, considering the scale at which the M-IoT devices operate, it may be challenging to detect any deviation in the behavior of an individual IoT device. With varied use cases and operational patterns, some of the conventional detection methods may not be viable at this scale. For example, it may be difficult to visualize device operational patterns and to detect any sub-optimal configurations that cause frequent network usage and communications. Moreover, large amounts of computational resources may be used to process such a large quantity of data corresponding to M-IoT devices.

Examples of the system implement an identification system and reconfiguration system at the core of the communication network to continuously identify IoT devices that are operating at non-optimal configurations and reconfigure those devices using adjustments to the IoT device configuration settings. The incremental reconfiguration of the IoT devices may be adjusted using adjustment values that are determined using a machine learning (ML) approach, like reinforcement learning, to maximize a reward function that predicts an increased battery lifetime for the device, among other objectives/rewards. For example, the agent of the reconfiguration system is configured to determine the optimal configuration for the IoT device by providing an adjustment value to reconfigure the configuration setting at the IoT device and receive feedback in the form of rewards or penalties. The agent, through the machine learning process, may determine a next/second adjustment value to try to maximize cumulative rewards over time. Over a sequence of interactions of the agent/reconfiguration system with the IoT device, the high-level objective will be to observe a decreasing trend in the energy consumption, which in turn corresponds to an improving, or increasing, trend in the battery lifetime.

As per some examples, the operational parameters may refer to various operational states of a device over a network. These operational states can be an uplink/downlink state, an idle state, a power saving state, etc. The uplink denoted as “UL” may refer to a process of sending data from a device to an IoT platform/application. The downlink denoted as “DL” may refer to a process of sending data from an IoT platform/application to a device. In some examples discussed herein, uplink and downlink operations may be performed via a communication system. In some examples, in an idle state, a device may be in a partial power saving state as it allows only downlink. Uplink operations may be suspended in an idle state. A power saving mode/state can be a deep sleep state, where a device may be registered on a network but may not allow uplink and downlink operations.

In some examples, the system may determine a subset of IoT devices that appear to operate similarly, that is exhibit similar communication characteristics, and generate a cluster of the subset of devices. The similar operations may be identified in log files that capture the transaction messages that IoT devices transmit and receive with the communication network. The system can determine an amount of energy consumption that the subset of IoT devices use and iteratively adjust a configuration setting to adjust the amount of energy consumption. When the energy consumption is compared between two values, the system can revert to the lower value and remove the configuration that created the greater energy consumption. The system can implement the adjustment to reduce the amount of energy consumption for the particular subset of IoT devices.

Additionally, the present disclosure provides techniques for the discovery of any misconfigurations and/or anomalies in the communication patterns of M-IoT devices. In the examples discussed herein, IoT devices may be low-power devices with power saving characteristics. Misconfiguration and/or anomalies may include infrequent and/or sub-optimal network usage (e.g., inefficient uplink, downlink, power saving, etc.), which may lead to poor power saving. The system can identify IoT devices that can be good candidates for reconfiguration in order to optimize power consumption of IoT devices in an M-IoT deployment.

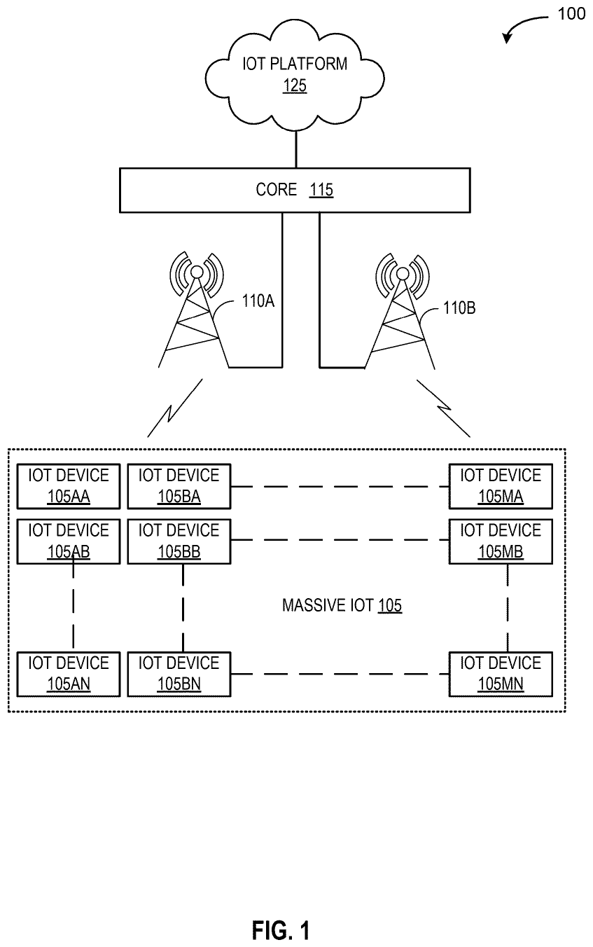

FIG. 1 illustrates an example of network environment that is used for optimization of power consumption of M-IoT devices. In example 100, M-IoT applications may use a large number of IoT devices (e.g., hundreds to millions of devices) that may not be latency-sensitive and may have low throughput. However, these IoT devices may consume low energy on a network. In some examples, M-IoT devices may be battery-powered devices, such as sensors, actuators, computing devices, etc. These devices can be tailored to fit any specific application and deployed in massive numbers, making them fit for use in M-IoT applications.

The network environment in example 100 may include M-IoT devices 105. The M-IoT devices 105 may be composed of a plurality of IoT devices 105AA-105AN, 105BA-105BN, . . . , 105MA-105MN, which may be low power devices with power savings capabilities. In some examples, the IoT devices 105AA-105MN may use a machine-to-machine protocol(s) over a Constrained Application Protocol (CoAP) for communication. Herein, the terms “M-IoT devices” and “plurality of IoT devices” may be interchangeably used. The network environment may correspond to M-IoT applications, such as asset tracking, smart organization, environmental monitoring, smart metering, smart manufacturing, monitoring building/campus/enterprise, etc. Further, the IoT devices may include medical devices, communication devices, household appliances, enterprise devices, and/or suitable networked devices. The plurality of IoT devices 105 may each be equipped with communication components to transmit/receive data to/from an application platform. The processing power and power consumption of this plurality of IoT devices 105 may vary depending on the use case, form factor, etc. The plurality of IoT 105 devices may sense and update data either periodically or when there may be a change in the sensed data, e.g., a change reaching or crossing a threshold value.

In various examples, the plurality of IoT devices 105 may be a constrained-type, e.g. have limited resources. For instance, these devices may have limited power sources, limited processing capability, and/or limited communicating capabilities. The plurality of IoT devices 105 may generate infrequent traffic using small data. In various examples, the plurality of IoT devices 105 may use low power consumption based protocols for communicating data with an IoT platform 125. The IoT platform 125 can be an integration of tools and services used for collection of data from the M-IoT devices 105. In one example, a smart gas meter may be an IoT device that periodically sends usage data to an IoT platform and may stay in a power saving mode or idle mode when not transmitting data. These IoT devices may include an active mode and an idle mode. In active mode, the IoT devices communicate data and in idle mode, they save energy by limiting communication in one or both directions. However, sensing or monitoring operations associated with the IoT devices may continue, per some examples.

Further, these M-IoT devices 105 may be communicatively connected to a communication system. In some examples, the communication system can be a 5G communication system with network slicing capabilities. The network environment may include one or more network access nodes, such as base stations 110A and 110B, of the communication system. In an example, the network access node may be a gNodeB in a 5G communication system. A gNodeB is a 5G base station that uses a New Radio (NR) technology with radios featuring Software Defined Radio (SDR) with various Multiple Input Multiple Output (MIMO) options. MIMO enables sending and receiving multiple data signals simultaneously over a common radio channel thereby offering larger network coverage/capacity to support M-IoT deployments. One or more network access nodes may interface with a core 115 of the communication system. For example, 5G Core (5GC) is a core of 5G communication systems that include a plurality of Network Functions (NFs) for managing subscription, authentication, access, routing, packet gateway control, etc. that form radio and network connections. Thus, the M-IoT devices 105 may form uplink and/or downlink connections for transmittal and/or receival of data, respectively. In some examples, an uplink connection may include an uplink registration. In some examples, an IoT device may perform an attach and/or a registration procedure with/without a Packet Data Network (PDN) connection. Thus, during an uplink operation, a device may first complete a registration procedure before communicating actual data. In some examples, a device may have to perform this registration procedure to communicate data after exiting a power saving mode or an idle mode.

As per various examples, the M-IoT devices 105 may be Narrow Band Internet of Things (NB-IoT) or Long Term Evolution Category M1 (LTE Cat-M1) based devices as defined by the Third Generation Partnership Project (3GPP). These standards may correspond to Low Power Wide Area Network (LPWAN). In some examples, these devices may have a Power Saving Mode (PSM) and/or an Extended Discontinuous Reception (eDRX) Mode.

In PSM, a device may disable its cellular radio but may stay registered to the network to stay in a power-saving mode, A device may negotiate two timers with the network. The two timers may include an active timer (e.g., T3324) and an Extended periodic Tracking Area Update timer (e.g., T3412). A device may activate PSM by including these two timer values during an attach or Tracking Area Update (TAU) operation. Periodically, a TAU may be used by the IoT device to notify the network regarding its availability. T3324 timer may indicate the duration for which a device might be available. A device may activate the T3324 timer when it moves from a “connected” to “idle” state. Upon expiration of the T3324 timer, the device moves to PSM. In PSM, a device may enter power saving mode thereby reducing power consumption. T3412 timer may define extended time for a device to send periodic TAU. The difference between these two timers (T3412-T3324) may define PSM time.

According to some examples, PSM may work in conjunction with eDRX mode or eDRX mode may be used independently. eDRX mode may be used to switch off the receiver of the device for a moment, such that the device may not be listening to the network. eDRX mode may also use two timers, namely, a Paging Cycle Length (PCL) and a Paging Time Window (PTW). PTW may correspond to an active state of an eDRX cycle. “Paging” may refer to informing and/or notifying a device about various events. A duration for which a device may be inactive or in a sleep state may be defined by eDRX cycle. Further, an eDRX cycle may be modified based on the use case. In some other examples, other power saving timer protocols, such as Discontinuous Transmission (DT), may be used.

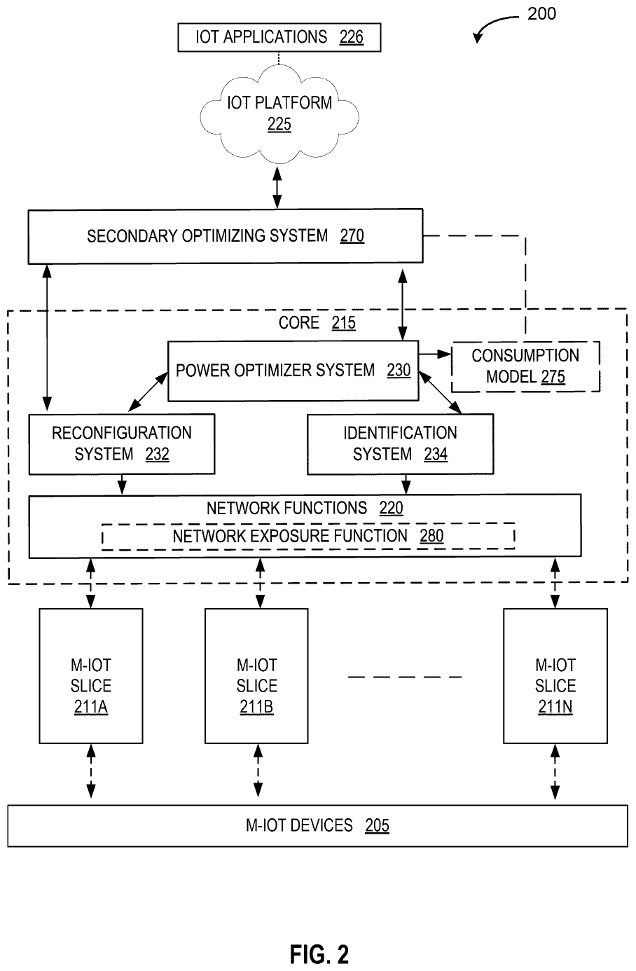

FIG. 2 illustrates a schematic representation of a discovery phase and reconfiguration phase corresponding to a method of optimizing operational parameters of IoT devices, according to various examples of the present disclosure. In example 200, a network environment is illustrated. The network environment may include M-IoT devices (a plurality of IoT devices) 205. M-IoT devices 205 may be of a homogeneous and/or heterogeneous type and may correspond to the same or different IoT solutions.

Core 215 may be a communication system, such as a 5G communication system for transmittal/receival of data. In some other examples, other communication systems, such as a Fourth Generation Long-Term Evolution (4G-LTE) or other standards defined by 3GPP can be used. In this example, core 215 comprises power optimizer system 230, reconfiguration system 232, identification system, 234, consumption model 275, network functions 220, and other features. Core 215 may connect with IoT platform 225 and IoT applications 226 (via secondary optimizing system 270) and a plurality of M-IoT devices 205 (via M-IoT slices 211), as further described herein.

M-IoT devices 205 may connect to core 215 of the communication system. Core 215 may be a 5G Core (5GC) of 5G communication systems that include a plurality of Network Functions (NFs) 220 for managing subscription, authentication, access, routing, packet gateway control, etc. that form radio and network connections. Thus, the M-IoT devices 205 may form uplink and/or downlink connections for transmittal and/or receival of data, respectively. In some examples, an uplink connection may include an uplink registration. In some examples, an IoT device may perform an attach and/or a registration procedure with/without a Packet Data Network (PDN) connection. Thus, during an uplink operation, a device may first complete a registration procedure before communicating actual data. In some examples, a device may have to perform this registration procedure to communicate data after exiting a power saving mode or an idle mode.

M-IoT devices 205 may connect to core 215 of the communication system via a plurality of IoT slices 211A-211N. IoT devices 205 under one IoT slice 211 may correspond to an application that uses low latency and high capacity. IoT devices 205 under another IoT slice 211 may correspond to autonomous devices that may work under moderate latency and high capacity. The communication system may provide shared network resources among various IoT solutions. This may be in addition to sharing of infrastructure (e.g., computing, network, storage) for applications/services in isolation. A consumption meter, such as a gas meter, electricity meter, or water meter may be used. Accordingly, during onboarding and/or activation of the plurality of IoT devices, availability timers (e.g., active timers) may be set. In one example, a default or preconfigured value may be selected for availability timers based on a use case or IoT device type. “Availability timers” may infer power-saving timers or operational parameters, as discussed herein.

Core 215 may include a plurality of Network Functions (NFs) 220. The NFs 220 may include a Network Exposure Function (NEF) 280 that allows exposure of specific network functionalities, interfaces, on a granular level from many network functions. For example, NEF 280 may facilitate secure access to network services and capabilities of the communication system (e.g., for accessing the availability timers).

The network environment in example 200 may also comprise secondary optimizing system 270. Secondary optimizing system 270 may be deployed as a gateway between IoT platform 225 and core 215. Secondary optimizing system 270 may be configured to adjust operational parameters, such as transport protocol parameters such that the existing availability timers/power saving timers of the plurality of IoT devices may be in synchronization with the protocol parameters. In one example, secondary optimizing system 270 may configure timers (e.g., eDRX timers, Paging Cycle Length (PCL), and Paging Time Window (PTW)) such that they are aligned with Constrained Application Protocol (CoAP) parameters (e.g., ACK_TIMOUT). This may limit the duplication of downlinks. In some examples, secondary optimizing system 270 may reduce/eliminate inefficiencies in downlink communication. In some examples, IoT platform 225 may send/re-send paging messages to IoT devices during their standby operation. The IoT devices may exhibit improved characteristics due to reduced network usage thereby improving the power consumption of the M-IoT devices 205.

Further, one or more IoT applications 226 may be deployed on IoT platform 225. In various examples, secondary optimizing system 270 may be a Service Capability Server (SCS) or a Service Capability Gateway (SCG) configured to provide an interface with 3GPP systems. Further, secondary optimizing system 270 may have access to existing operational parameter records (e.g., log files).

Core 215 may also comprise power optimizer system 230, identification system 234, reconfiguration system 232, consumption model 275, and network functions 220. For example, power optimizer system 230 may retrieve uplink and downlink data and operational parameters from log files. The log files may be built by the secondary optimizing system 270, or network functions 220 of the core 215.

Power optimizer system 230 may estimate a Power Cost Function (PCF) by utilizing the consumption model 275. For example, PCF may be estimated for each IoT device of the M-IoT devices 205 by correlating connectivity attempts based on availability timers, with application transmissions attempts when IoT platform 225 communicates with M-IoT devices 205. For example, correlation information may indicate whether during an availability timer/active cycle (e.g., device awake) a complete exchange of data between the device and an IoT application has occurred. In some examples, “availability timers” may refer to an active timer/T3324 during which an IoT device may be accessible and a sleep timer/T3412 during which the IoT device may perform an attach procedure. In some examples, “availability timers” may correspond to power saving timers, such as paging time window, PCL, or PTW as defined in the eDRX standard.

In some examples, supervised or unsupervised Machine Learning (ML)/Artificial Intelligence (AI) techniques may be applied to estimate PCF. In various examples, the AI/ML techniques may be applied to the uplink-downlink data, which can be used as the basis for estimating the PCF function. The estimated PCF can then be used to identify optimal timer values. The optimal timer values may be inferred from the analyzed values for the time differences between successive uplink and downlink session information of an IoT device with the IoT platform 225 or 5G M-IoT slices 211A-211N.

In some examples, M-IoT devices 205 may be reconfigured with the optimal timer values such that the IoT device(s) may consume optimal network resources for uplink and downlink messages upon reconfiguration. Accordingly, M-IoT devices may consume power optimally thereby, for example, improving battery life of devices and reducing the need for frequent battery replacements. In various examples, the optimal availability timer value(s) may be a function of additional parameters, such as local peculiarity, seasonality, weather, location, or other factors. In some examples, AI/ML techniques can refer to methods that, through the use of algorithms (e.g., K-Means clustering algorithm, Prefix-span-based sequential pattern mining algorithm, etc.), may provide informational models based on input data, which may not be visually or analytically perceived by humans. In ongoing examples, implementation of the optimizing system(s) may include machine learning techniques in enterprise environments, e.g., businesses, that help provide better services and products to customers, due to efficient usage of networks, optimal power consumption, etc.

Power optimizer system 230 and secondary optimizing system 270 may have access to consumption model 275. In various examples, consumption model 275 may include power consumption metrics for various operations performed by various categories of devices deployed in M-IoT deployment. For example, power consumption metrics for each operation, such as paging, standby, uplink, downlink, etc. may be recorded or made available in the consumption model. For example, power consumption may be in milliampere-hour (mAh).

In some examples, power optimizer system 230 may estimate a Power Cost Function (PCF) by utilizing the consumption model 275 or by determining optimal parameters in view of seasonality, weather, or other local parameters. In some examples, sample data from certain IoT devices may be captured for various use cases that are organized per geographical clusters and operated regularly to capture seasonality and/or weather dimensions.

Core 215 may also comprise identification system 234. Identification system 234 is deployed in core 215 to determine and identify devices that are performing below optimal levels, as discussed with uplink/downlink operations described herein. The system may determine the devices by mining communications transmitted from M-IoT devices 205 or analyzing communications that are stored as log files to establish a communication profile for the devices.

Identification system 234 may generate the communication profile for each device from the communications or stored log files. The communication profile may comprise a number of messages between IoT applications 226 or core 215 and the M-IoT devices 205. The communication profile may also identify the direction of each communication (e.g., to/from the device) and their frequency, such as per day, week, or month.

In some examples, the communication profile and device configuration are determined. The configurations of devices may be determined from secondary optimizing system 270. The configuration for the device may be based at least in part on the timer's values, which are discrete. The possible configurations for the devices may be extensive yet finite.

The configuration may be passed to the power optimizer system 230 for inspection which may organize the devices in clusters using their communication profiles. The clusters may be based on the obtained operational parameters. For example, an IoT device may consume “x” amount of power for each uplink operation, “y” amount of power for each downlink operation, “z” amount of power during standby operation, etc. A cumulative (x+y+z . . . ) of power consumed for these operations may be used to estimate overall consumption. This may enable the processor to predict the overall power consumption of each IoT device during its operation over a time horizon. Further, the processor may determine a period for which the battery of IoT may last or may warrant a replacement/maintenance. That is, the processor may be configured to extrapolate the power consumption to determine the lifetime of a power source, such as a battery.

In some examples, a subset of the IoT devices out of the plurality of IoT devices may exhibit different patterns of operational parameters. For example, certain devices within a cluster may exhibit frequent uplink and/or downlink states, which may cause higher power consumption when compared to other devices within the same cluster. This may cause those IoT devices to thereby exhibit erratic power consumption patterns. In some examples, time-series data from the operational parameter records of the plurality of IoT devices may be processed using unsupervised AI/ML technique(s) to discover any anomalies in communication patterns of the plurality of the IoT devices.

In some examples, the clusters are formed based on device type or location. IoT devices may be used to form a cluster when the devices have similar physical properties that are grouped together to form a cluster.

The subset of IoT devices and configuration settings of the IoT devices may be transmitted/passed to the reconfiguration system 232. In some examples, candidate configuration settings are also transmitted. Reconfiguration system 232 may implement an iterative and continuous configuration process that determines a more optimal configuration of the IoT devices. In some examples, the reconfiguration process is automated and autonomous.

Reconfiguration system 232 may discover which configuration settings yield the most reward through experimentation or reinforcement learning. For example, reconfiguration system 232 is configured to operate an agent during a machine learning process (e.g., reinforcement learning) to determine the optimal configuration for the IoT device. The agent provides the adjustment value to reconfigure the configuration setting at the IoT device and receives feedback in the form of rewards or penalties. The agent, through the machine learning process, may determine a next/second adjustment value to try to maximize cumulative rewards over time.

In some examples, the selection of the adjustment value for the configuration settings may yield an immediate reward and also a subsequent reward in the reinforcement learning context. Each time the agent changes the configuration setting of the device by the adjustment value, the system receives feedback from the IoT device.

In some examples, the feedback to the agent during the machine learning process may be received as log files. Using the log files, reconfiguration system 232 may determine the current energy consumption of the device and hence the associated battery life. Over a sequence of interactions of the agent with the IoT device, the high-level objective will be to observe a decreasing trend in the energy consumption, which in turn corresponds to an improving, or increasing, trend in the battery lifetime.

In some examples, the initial setting or configuration of the IoT device may be a predetermined value. Reconfiguration system 232 can configure the IoT device to change the configuration setting by an adjustment value. The configuration setting and adjustment value of the configuration setting is determined by the reinforcement learning process, where the objective is to optimize the energy consumption of the IoT device such that the battery lifetime is maximized. The reward function may be based on the energy consumed by the IoT device to discharge its routine functions. The state space consists of the sets of configuration settings applied to the IoT device. Actions are the combination of configuration changes applied to the IoT device.

Reconfiguration system 232 is configured to deploy a reward function as part of the reinforcement learning process. The reward may correspond with the optimization target. For example, in the IoT configuration task, the desired configurations are the ones that optimize (e.g., reduce) energy consumption thus extending the battery lifetime. The immediate rewards are improvements in the energy consumption, that is reduction in battery consumption.

For example, let E(t) represent the energy consumed by an IoT device in the previous time period, that is between t and (t−1). Similarly, E(t−1) represents the energy consumed during the time period (t−1) and (t−2) prior to time period t. Let EC(t) denote the percentage change in energy consumption during a particular period of time t.

$$EC ( t ) = ( E ( t ) - E ( t - 1 ) ) / E ( t - 1 ) \qquad ( 1 )$$

Then the improvement in energy consumption can be assigned a score as follows, which identifies the improvement as energy is reduced:

$$s ( t ) = - 1 if EC > 0 : s ( t ) = 0 if EC = 0 ; s ( t ) = 1 if EC < 0 \qquad ( 2 )$$

A negative score implies that the most recent configuration changes are not improving battery consumption or reducing energy consumption. A medium to high positive score implies that the most recent configuration changes are taking us towards the long-term objective of improving battery lifetime or reducing energy consumption.

The reward function of the machine learning process may correspond with a numerical signal provided by the IoT device to indicate the immediate benefit or cost associated with the agent's adjustment to the configuration setting, in this case, the reward function is defined as reward (t)=s(t). The goal of the agent is to maximize cumulative rewards over time.

The state space is defined to be the set of possible configuration parameters that are applied to the IoT device. An illustrative correlation between the state space, action, time, and reward are provided in table 1.

TABLE 1
State Space table

| Time step | State | Action | Reward |
|---|---|---|---|
| T₁ | S₁ | [p₁₁; p₁₂; p₁₃; : : : ; p₁ₖ] | s(1) * γ |
| T₂ | S₂ | [p₂₁; p₂₂; p₂₃; : : : ; p₂ₖ] | s(2) * γ2 |
| T₃ | S₃ | [p₃₁; p₃₂; p₃₃; : : : ; p₃ₖ] | s(3) * γ³ |
| : : : | : : : | : : : | : : : |
| Tₙ | Sₙ | [pₙ₁; pₙ₂; pₙ₃; : : : ; pₙₖ] | s(n) * γⁿ |

Here g is the rate at which the battery gets drained where 0<g<1. Selecting a value of g between 0 and 1 implies that we are looking at not only immediate rewards, but rewards accumulating over multiple time periods.

The actions a (t) constitutes the changes made to the configuration parameters at time t. The Q function is defined as:

$$Q ( s ( t ) , a ( t ) ) = s ( 1 ) * γ + s ( 2 ) * {γ}^{2} + \begin{matrix}: & : & :\end{matrix} + s ( n ) * {γ}^{*} ; where 0 < γ <= 1 \qquad ( 3 )$$

The RL algorithm continuously improves its policy by collecting information about the environment dynamics. The expected value of the return obtained by starting in a state S, choosing an action a, and following a policy p gives us the Q function for the policy p. The Value Function may be learned during the initial experimentation cycle.

According to further examples, the techniques disclosed herein for optimization of power usage by optimizing network usage and for reconfiguration of M-IoT devices may involve a discovery phase, an identification phase, and a reconfiguration phase as elaborated in subsequent examples.

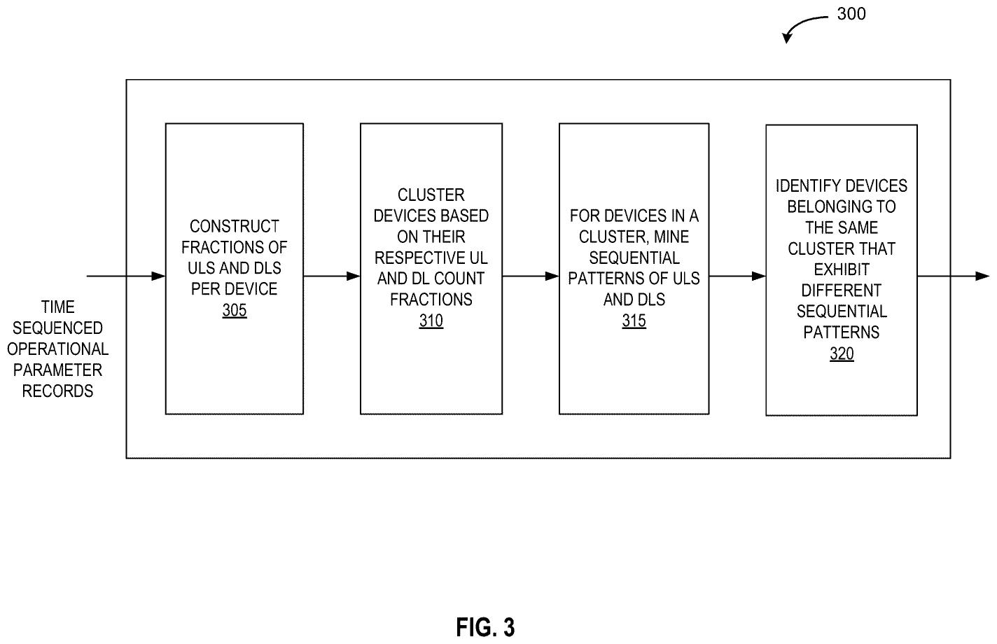

FIG. 3 illustrates a schematic representation of a discovery phase for anomalies and/or misconfiguration of M-IoT devices. In example 300, an illustrative discovery phase of M-IoT devices is shown. In the discovery phase, frequent sequential patterns may be mined by the power optimizer system to identify any anomalies and/or misconfiguration of IoT devices. In various examples, for mining frequent sequential patterns, operational parameters based on which uplink and downlink session frequencies are configured may be received by a power optimizer system. The operational parameters may be obtained over a time horizon for a plurality of IoT devices.

In some examples, the time series/time-sequenced operational parameter records of the M-IoT devices are received by the power optimizer system. Uplink and downlink time-sequenced data can be extracted from these operational parameter records. In some examples, the operational parameter records may refer to log files that are related to uplinks, where “uplink data” may include registration uplink and payload uplink. Further, an interval between registration uplink and payload uplink, and/or an interval between payload uplinks may be considered.

At block 305, the process may construct fractions of uplink and downlink data per IoT device. Using the uplink and downlink data, fractions of observed uplinks (UL) and downlinks (DL) may be calculated for multiple IoT devices. For example, a fraction of uplink (UL) and (DL) data may be based on UL and DL counts divided by the total number of ULs and DLs per device for a given time horizon. The percentages of ULs and DLs per device may be gathered for various devices. In one example, the percentages of ULs and DLs may be used as the input dimensions to assemble clusters using an unsupervised clustering algorithm.

At block 310, the process may cluster the IoT devices based on their respective uplink and downlink data. In some examples, fractioned UL and DL data may be used to cluster devices based on their respective UL and DL count fractions. The plurality of IoT devices may be clustered into a plurality of clusters/families. The process may cluster the IoT devices using unsupervised machine learning, for example, a K-Means algorithm may be used to cluster the fractional counts of ULs and DLs per device. A variety of clustering approaches may be used for categorizing these devices. In one example, a standard K-Means clustering can be performed. In another example, in addition to the K-Means algorithm for clustering, hashing, vectorization, or other normalization techniques may be employed based on the complexity of operational data. In further examples, clustering techniques, such as hierarchical, Density-Based Spatial Clustering of Applications with Noise (DBSCAN), and cluster analysis while Dimension Reduction (DR) tasks most often use Principal Component Analysis (PCA), Linear Discriminant Analysis (LDA), Non-Negative Matrix Factorization (NNMF) and autoencoder methods to reduce the computational complexity.

In some examples, for given data, an attribute may be provided for UL or DL referred to as the “resource path”. The resource path attribute may be used to partition UL and DL records into separate sub-families of records. The resource path could be used as a categorical variable to achieve refined grained clustering. This enables devices assigned for a specific function to be categorized within the same cluster.

At block 315, the process may mine the sequential patterns of UL and DL data for devices in the same cluster. In one example, a Prefix-Span-based sequential pattern mining technique(s) may be used for mining sequential patterns. Pattern mining techniques may enable the discovery of various patterns from data. Various patterns can be based on one or more of frequent item set(s), association(s), sequential rule(s), and periodic pattern(s). In other words, sub-sequences may be mined for sequential data based on various criteria. The criterion may include a frequency, length, and/or a pattern of occurrence of subsequences. In the current examples, “frequent sequential patterns” may be used to mine the most frequent patterns of ULs and DLs in non-overlapping, contiguous, time slices.

At block 320, devices belonging to the same cluster but exhibiting different sequential patterns may be identified through frequent sequential patterns. In various examples, devices within a cluster may exhibit different sequential patterns. Thus, the discovery of anomalous sequential patterns may be achieved, which can be due to misconfiguration during onboarding and/or due to variations over time. On discovery of anomalous sequential patterns, AI/ML techniques enable identification of devices, which can be good candidates for the configuration of optimal parameters such that the energy consumption of the M-IoT devices may be optimized and battery life may be extended.

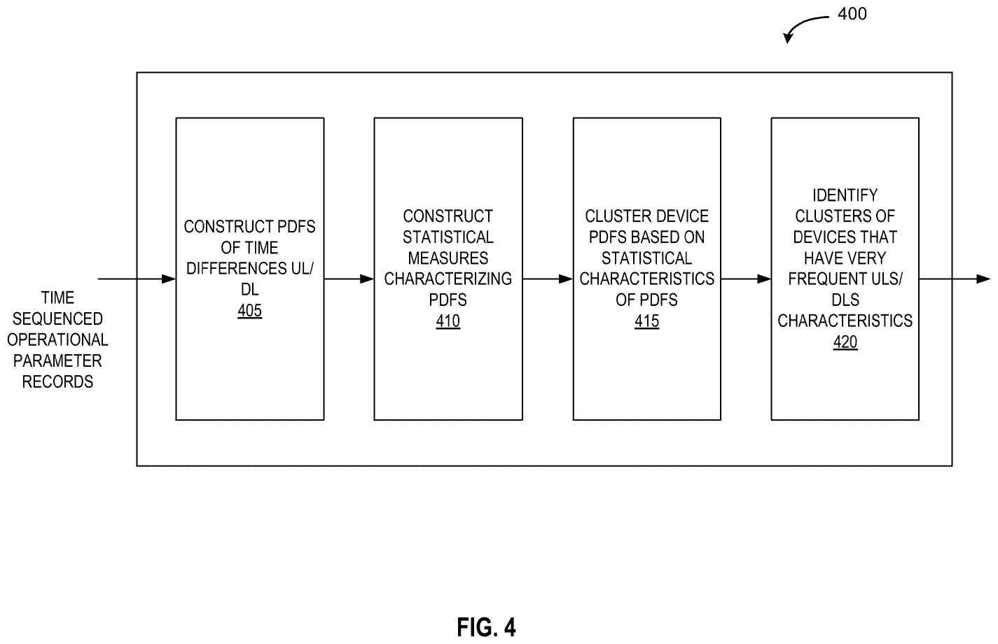

FIG. 4 illustrates a schematic representation of an identification and reconfiguration phases of M-IoT devices. In example 400, an identification and reconfiguration phase is shown. For example, based on the discovery of anomalies/misconfigurations of the M-IoT devices, the identification may be performed through an analysis of the statistics of the time differences/intervals between successive ULs and DLs, for different categories of devices (e.g., between clusters of devices).

At block 405, the process may construct a discrete probability distribution function of time differences between successive ULs and DLs for different categories of devices (e.g., inter UL/DL time differences).

At block 410, the process may characterize the Probability Distribution Function (PDF) using statistical measures. For example, the statistical measures may comprise minimum and maximum values, mean, median, mode, standard deviation, deciles, quartiles, quintiles, skewness, and/or kurtosis.

At block 415, the process may cluster the plurality of IoT devices using the statistical characteristics of the PDFs of the devices. The clustering performed during this phase may aggregate devices with similar statistical characteristics or PDFs. For instance, devices found in one cluster may have UL and DL data with similar or “nearer” statistical characteristics. Whereas devices from different clusters may have UL and DL data with statistical characteristics “distant” or “far away” from one another when compared to UL, DL data from devices within the same cluster.

In various examples, the statistical measures of the probability distributions of time differences between successive ULs and/or DLs for each device may be used to construct a vector for each device. Dimensions of the vector may represent statistical characteristics of the probability distribution. In one example, this may be a feature engineering part of the AI/ML techniques. That is, clustering of devices based on characteristics of probability distribution functions. For example, a K-Means algorithm may be used to break probability distributions into clusters of similar probability distributions. Similarly, in some examples, asymmetric distance between PDFs, also known as the resistor-average distance, derived from the asymmetric Kullback-Leibler distance, may be used as the distance metric to cluster the PDFs of the devices.

At block 420, the process may identify clusters of devices using the clustered probability distribution functions data that have similar ULs/DLs characteristics. In various examples, to identify clusters of devices with similar UL/DL data characteristics, the clusters may be ranked based on values of the dimensions/features of the vectors representing the centroid of each cluster. “Centroid” can be an imaginary or real location representing the center of the cluster. For a K-Means algorithm, the “K” number of centroids may be selected. Further, data points can be allocated to the nearest cluster and a smallest value within the cluster is selected as the centroid iteratively. According to techniques disclosed herein, upon clustering the UL/DL characteristics, a cluster with the smallest values of the features may be a cluster of devices that can be selected as good candidates for optimizing the timers to optimize energy/battery consumption. In some examples, the smallest values of features may indicate a higher frequency of occurrence of uplink/downlink operations.

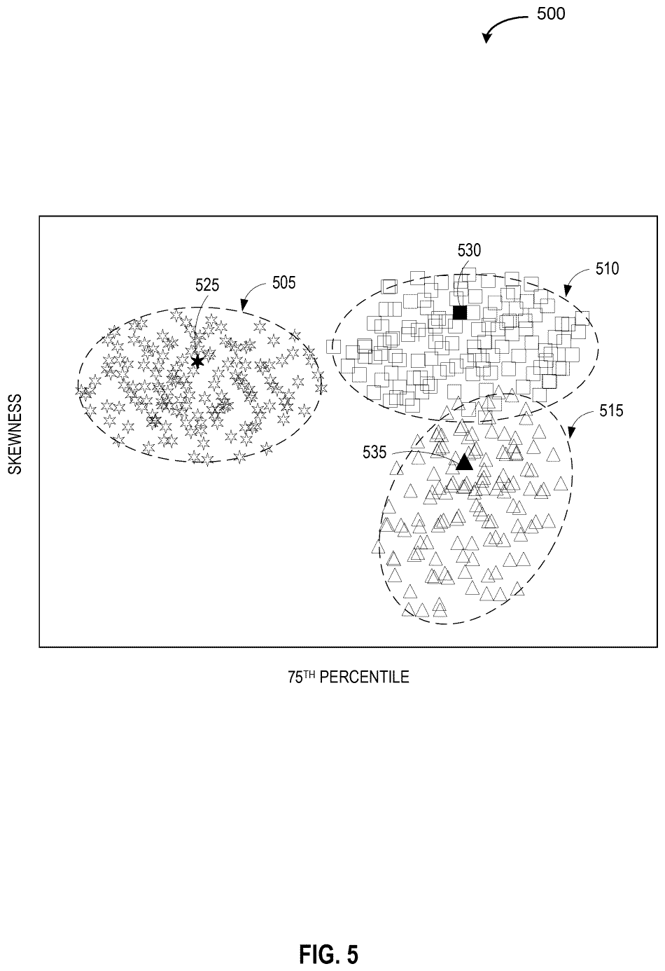

FIG. 5 illustrates a schematic view of a graph depicting three clusters of IoT devices, according to various examples. In example 500, clusters of M-IoT devices is illustrated. The plurality of IoT devices may be grouped into three clusters 505, 510, and 515. The clusters may include a centroid 525, 530, and 535, respectively. IoT devices with similar probability distribution functions may be classified under one cluster. The shape identified in the clusters 505, 510, and 515 (e.g., star, square, and triangle) may represent a probability distribution function corresponding to an IoT device.

For example, the power optimizer system may identify a cluster with the smallest values of features (e.g., statistical measures) among the clusters. The identified cluster and corresponding devices can be candidates for optimizing their timers to optimize energy/battery consumption. In some examples, the clusters may be ranked based on statistical characteristics of probability distribution functions. From the ranked clusters, clusters with the smallest values of statistical measure. In some examples, more than one feature of the vector may be used for representing the centroids and for ranking accordingly. The selection of feature(s) for centroid may be determined by a network administrator.

In some examples, a skewness, as a feature, is plotted for the 75th percentile. From the ranked clusters, cluster(s) with the lowest values of a particular dimension/feature may indicate that devices within that cluster may be misconfigured. Misconfiguration may cause devices within that cluster may be high power consumption, resulting in frequent discharges of the battery. In some examples, statistical measures/characteristics may include statistics that may be descriptive coefficients capable of summarizing the entire cluster or a sample of a cluster. Some of the statistical measures can be indicative of central tendency, whereas others can be measures of spread (of data). Mean, median, and mode may be measures of central tendency. Standard deviation, variance, minimum and maximum, kurtosis, and skewness may be measures of the spread. The clusters may be ranked based on the centroid 525, 530, and 535 representing one or more of these statistical measures.

In some examples, the power optimizer system may apply the optimal parameters (e.g., active timers) that are identified during power consumption estimation to a selected cluster of IoT devices (e.g., the cluster 515 which may have the smallest ranking). In some examples, the power optimizer system may modify the active timers such as the misconfigured or sub-optimal configuration of IoT devices may be reconfigured with optimal timers. In other examples, reconfiguration of power saving timers may be performed via network exposure functions (e.g., NEF 280 of FIG. 2). This enables the plurality of IoT devices to establish uplink and be available for downlink for optimal data transfer, energy consumption, and battery life.

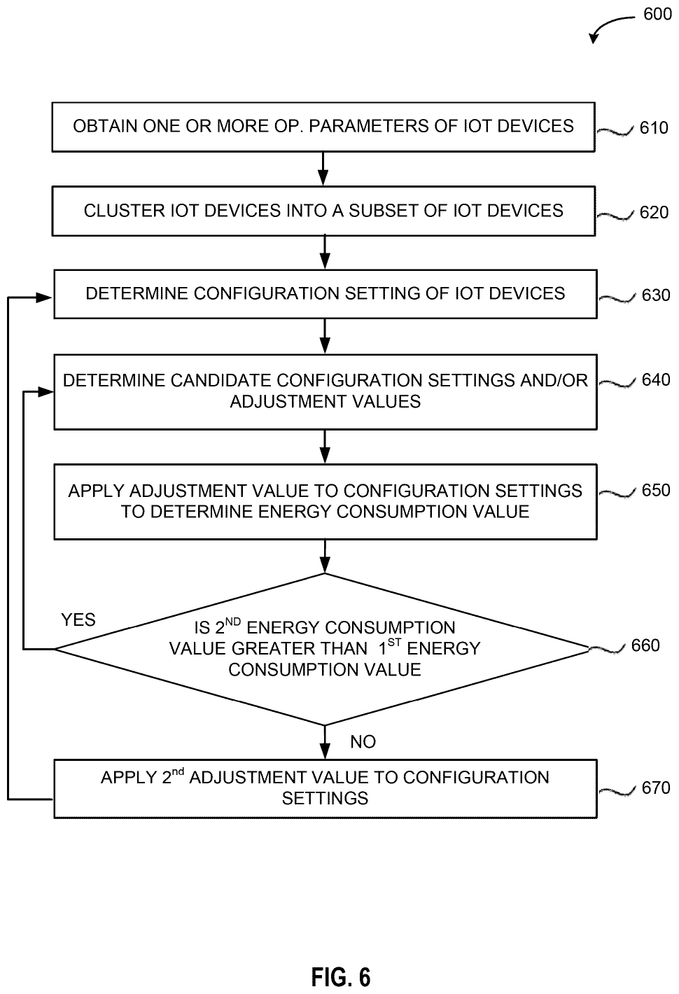

FIG. 6 illustrates a flow diagram corresponding to a method for performing optimization of operational parameters of M-IoT devices, according to various examples of the present disclosure. In example 600, various systems may execute machine readable instructions to cause a processor to perform the operations and processes described herein, including any system illustrated in FIG. 2

At block 610, the system (e.g., at the core via power optimizer system) may obtain one or more operational parameters of the plurality of IoT devices. In some examples, operational parameters such as uplink (UL) data and downlink (DL) data may be obtained, as these may contribute to higher power consumption. For example, IoT devices may use various onboard resources including a processor, a storage medium, and a radio component such that stored data is retrieved and communicated via the radio component to the IoT platform. The uplink and downlink data (e.g., uplink and downlink time, number of uplinks and downlinks over a time horizon, etc.) may be retrieved from log files. The log files may be stored in at least one of a VNF/CNF or a network function at the core, an interfacing component, a server configured to store the log files, or the power optimizer system itself. In one example, the interfacing device may be the secondary optimizing system deployed functionally between the IoT platform and the core.

At block 620, the system (e.g., at the core via identification system) may cluster IoT devices into a subset of IoT devices. In some examples, the AI/ML may be used to cluster IoT devices into a subset of IoT devices (e.g., K-Means clustering algorithm, Prefix-span-based sequential pattern mining algorithm, etc.). In various examples, a K-Means algorithm may be used to cluster the fractional counts of ULs and DLs per device. In another example, in addition to the K-Means algorithm for clustering, hashing, vectorization, or other normalization techniques may be employed based on the complexity of operational data. In further examples, clustering techniques, such as hierarchical, Density-Based Spatial Clustering of Applications with Noise (DBSCAN), and cluster analysis while Dimension Reduction (DR) tasks most often use Principal Component Analysis (PCA), Linear Discriminant Analysis (LDA), Non-Negative Matrix Factorization (NNMF) and autoencoder methods to reduce the computational complexity.

In some examples, for given data, an attribute may be provided for each UL or DL referred to as the “resource path”. The resource path attribute may be used to partition UL and DL records into separate sub-families of records. The resource path could be used as a categorical variable to achieve refined grained clustering. This enables devices assigned for a specific function to be categorized within the same cluster.

For each cluster out of the plurality of clusters, frequent sequential patterns of UL and DL data may be mined for devices in the same cluster. In various examples, time series of UL and DL data of devices in the same cluster may be used to identify frequent sequential patterns. In one example, a Prefix-Span-based sequential pattern mining technique(s) may be used for mining sequential patterns. Pattern mining techniques may enable the discovery of various patterns from data. Various patterns can be based on one or more of frequent item set(s), association(s), sequential rule(s), and periodic pattern(s). In other words, sub-sequences may be mined for sequential data based on various criteria. The criterion may include a frequency, a length, and/or a pattern of occurrence of subsequences. In the current examples, “frequent sequential patterns” may be used to mine the most frequent patterns of ULs and DLs in non-overlapping, contiguous, time slices.

In some examples, the plurality of IoT devices may be clustered using the statistical characteristics of the PDFs of the devices. The clustering performed during this phase may aggregate devices with similar statistical characteristics or PDFs. For instance, devices found in one cluster may have UL and DL data with similar or “nearer” statistical characteristics. Whereas devices from different clusters may have UL and DL data with statistical characteristics “distant” or “far away” from one another when compared to UL, DL data from devices within the same cluster.

In some examples, the statistical measures of the probability distributions of time differences between successive ULs and/or DLs for each device may be used to construct a vector for each device. Dimensions of the vector may represent statistical characteristics of the probability distribution. In one example, this may be a feature engineering part of the AI/ML techniques. That is, clustering of devices based on characteristics of probability distribution functions. For example, a K-Means algorithm may be used to break probability distributions into clusters of similar probability distributions. Similarly, in some examples, asymmetric distance between PDFs, also known as the resistor-average distance, derived from the asymmetric Kullback-Leibler distance, may be used as the distance metric to cluster the PDFs of the devices.

The clustered probability distribution functions data may be used to identify clusters of devices that have similar ULs/DLs characteristics. In various examples, to identify clusters of devices with similar UL/DL data characteristics, the clusters may be ranked based on values of the dimensions/features of the vectors representing the centroid of each cluster. “Centroid” can be an imaginary or real location representing the center of the cluster. For a K-Means algorithm, the “K” number of centroids may be selected. Further, data points can be allocated to the nearest cluster and a smallest value within the cluster is selected as the centroid iteratively. According to techniques disclosed herein, upon clustering the UL/DL characteristics, a cluster with the smallest values of the features may be a cluster of devices that can be selected as good candidates for optimizing the timers to optimize energy/battery consumption. In some examples, the smallest values of features may indicate a higher frequency of occurrence of uplink/downlink operations.

At block 630, the system (e.g., at the core via identification system) may determine configuration settings of the subset of IoT devices. For example, the power optimizer system may identify a cluster with the smallest values of features (e.g., statistical measures) among the clusters. The identified cluster and corresponding devices can be candidates for optimizing their timers to optimize energy/battery consumption. In some examples, the clusters may be ranked based on statistical characteristics of probability distribution functions. From the ranked clusters, clusters with the smallest values of statistical measure. In some examples, more than one feature of the vector may be used for representing the centroids and for ranking accordingly.

Configuration settings may be various features of the IoT devices. for example, the uplink and downlink data may be logged, and the power optimizer system may retrieve operational parameters from log files. The power optimizer system may estimate a Power Cost Function (PCF) by utilizing a consumption model. In other words, a PCF may be estimated for each IoT device of the M-IoT devices by correlating connectivity attempts based on availability timers, with application transmissions attempts when the IoT platform communicates with the M-IoT devices. For example, correlation information may indicate whether during an availability timer/active cycle (e.g., device awake) a complete exchange of data between the device and an IoT application has occurred. As alluded earlier, connectivity attempts of the IoT devices with the network and the application transmission attempts of the IoT application with the IoT device may be performed during an active period. Further, according to one example, “availability timers” may refer to an active timer/T3324 during which an IoT device may be accessible and a sleep timer/T3412 during which the IoT device may perform an attach procedure. In some examples, “availability timers” may correspond to power saving timers, such as paging time window, PCL, or PTW as defined as eDRX in the 3GPP standard.

At block 640, the system (e.g., at the core via power optimizer system) may determine candidate configuration settings and/or adjustment values. The adjustment value may correspond with optimal parameters (e.g., active timers) that are identified during power consumption estimation. In some examples, the power optimizer system may modify the active timers such as the misconfigured or sub-optimal configuration of an IoT device may be reconfigured with optimal timers.

In some examples, the configuration setting may be determined using a reconfiguration system (e.g., reconfiguration system 232). For example, the process may discover which configuration settings yield the most reward through experimentation or reinforcement learning. In either instance, the process may provide a first adjustment value to reconfigure the configuration setting at the IoT device and receive feedback in the form of rewards or penalties. When an agent is used in reinforcement learning, the process may also determine a next/second adjustment value to try to maximize cumulative rewards over time.

In some examples, the initial setting or configuration of the IoT device may be a predetermined value. The process can configure the IoT device to change the configuration setting by an adjustment value. The configuration setting and adjustment value of the configuration setting is determined by the reinforcement learning process, where the objective is to optimize the energy consumption of the IoT device such that the battery lifetime is maximized. The reward function may be based on the energy consumed by the IoT device to discharge its routine functions.

At block 650, the system (e.g., at the core via reconfiguration system) may apply an adjustment value to a configuration setting to determine an energy consumption value. For example, the IoT device may be reconfigured with power saving timers/active timers using device management and service enablement protocols, such as Open Mobile Alliance Lightweight Machine to Machine (OMA LwM2M) protocol over a Constrained Application Protocol (CoAP) transport. In some communication systems, due to certain network conditions, such as poor signal strength, high network traffic, interference(s), or the like, the network can be unstable and/or experience low throughput. CoAP may be a specialized web transfer lightweight and compact protocol operable over unstable and/or low-throughput networks for use with constrained devices/networks. It may be used for Machine-to-Machine (M2M) applications such as smart devices, building automation, or the like. In some examples, CoAP may comply with Internet Engineering Task Force (IETF) RFC 7252 specification.

In some examples, application of the adjustment value for the configuration settings may yield an immediate reward and also a subsequent reward in the reinforcement learning context. Each time the agent changes the configuration setting of the device by the adjustment value, the system receives feedback from the IoT device.

In some examples, the feedback to the agent during the machine learning process may be received as log files. Using the log files, the process may determine the current energy consumption of the device and hence the associated battery life. Over a sequence of interactions of the agent with the IoT device, the high-level objective will be to observe a decreasing trend in the energy consumption, which in turn corresponds to an improving, or increasing, trend in the battery lifetime.

In some examples, the process may deploy a reward function as part of the reinforcement learning process. The reward may correspond with the optimization target. For example, in the IoT configuration task, the desired configurations are the ones that optimize (e.g., reduce) energy consumption thus extending the battery lifetime. The immediate rewards are improvements in the energy consumption, that is reduction in battery consumption.

In some examples, reconfiguration of power saving timers may be performed via network exposure functions (e.g., the NEF 280 of FIG. 2). The reconfiguration may apply the determined adjustment value to the configuration setting. This enables the plurality of IoT devices to establish uplinks and be available for downlinks for optimal data transfer, energy consumption, and battery life.

At block 660, the system (e.g., at the core via reconfiguration system) may determine if a second energy consumption value is greater than the first energy consumption value. If the second energy consumption value is greater than the first energy consumption value, the method returns to block 640 to determine additional candidate configuration settings and/or adjustment values. If the second energy consumption value is not greater than the first energy consumption value, the method proceeds to block 670. In some examples, the decision between using a first configuration setting and a second configuration setting is part of an iterative process for determining an optimal configuration setting for the IoT device.

At block 670, core 215 (e.g., via reconfiguration system 232 of FIG. 2) may apply the second adjustment value to a configuration setting. The application of the second adjustment value may be implemented using the features discussed herein (e.g., using device management and service enablement protocols, CoAP).

In some examples, the reconfiguration system may trigger a secondary optimizing system to adjust parameters of the transport protocol that may be used to communicate with IoT devices (downlink communication optimization). Whereas, based on a condition that the cluster does not exhibit any difference in frequent sequential patterns, the power optimizer system may reperform discovery phase related blocks.

It should be noted that the terms “optimize,” “optimal” and the like as used herein can be used to mean making or achieving performance as effective or perfect as possible. However, as one of ordinary skill in the art reading this document will recognize, perfection cannot always be achieved. Accordingly, these terms can also encompass making or achieving performance as good or effective as possible or practical under the given circumstances, or making or achieving performance better than that which can be achieved with other settings or parameters.

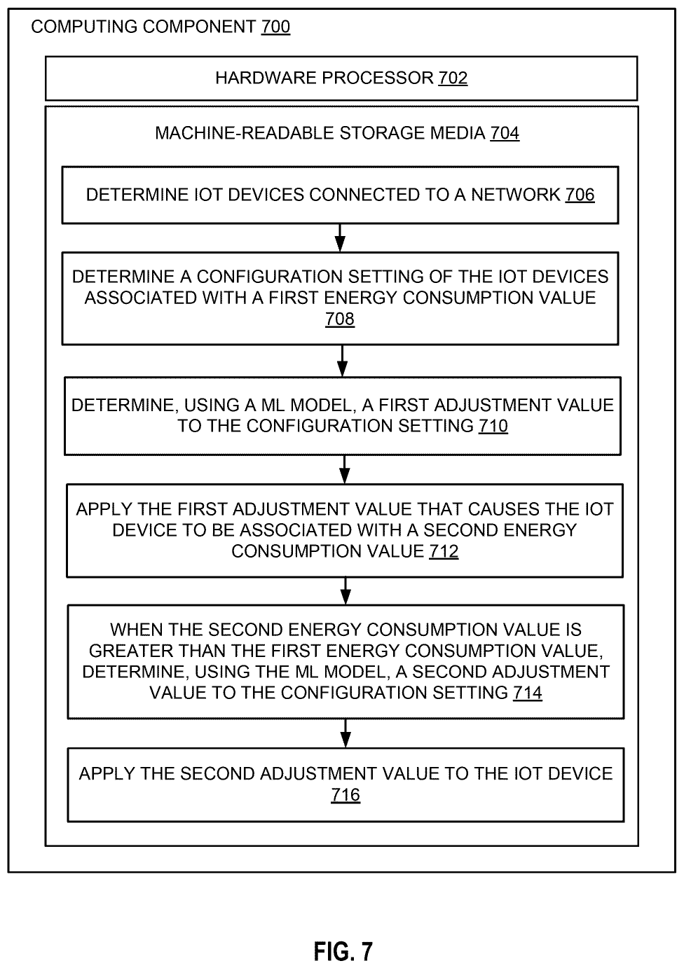

FIG. 7 illustrates an example computing component that may be used to implement burst preloading for available bandwidth estimation in accordance with various examples. Referring now to FIG. 7, computing component 700 may be, for example, a server computer, a controller, or any other similar computing component capable of processing data. In the example implementation of FIG. 7, the computing component 700 includes a hardware processor 702, and machine-readable storage media 704.

Hardware processor 702 may be one or more central processing units (CPUs), semiconductor-based microprocessors, and/or other hardware devices suitable for retrieval and execution of instructions stored in machine-readable storage medium 704. Hardware processor 702 may fetch, decode, and execute instructions, such as instructions 706-716, to control processes or operations for burst preloading for available bandwidth estimation. As an alternative or in addition to retrieving and executing instructions, hardware processor 702 may include one or more electronic circuits that include electronic components for performing the functionality of one or more instructions, such as a field programmable gate array (FPGA), application specific integrated circuit (ASIC), or other electronic circuits.

A machine-readable storage medium, such as machine-readable storage medium 704, may be any electronic, magnetic, optical, or other physical storage device that contains or stores executable instructions. Thus, machine-readable storage medium 704 may be, for example, Random Access Memory (RAM), non-volatile RAM (NVRAM), an Electrically Erasable Programmable Read-Only Memory (EEPROM), a storage device, an optical disc, and the like. In some examples, machine-readable storage medium 704 may be a non-transitory storage medium, where the term “non-transitory” does not encompass transitory propagating signals. As described in detail below, machine-readable storage medium 704 may be encoded with executable instructions, for example, instructions 706-716.

Hardware processor 702 may execute instruction 706 to determine IoT devices connected to a network. The IoT devices may connect to a communication system, such as a 4G-LTE or 5G communication system, for transmittal/receival of data.

In some examples, the IoT devices are also connect to a core of the communication system via IoT slices. IoT devices under one IoT slice may correspond to an application that uses low latency and high capacity, and another IoT slice may correspond to autonomous devices that may work under moderate latency and high capacity.

In some examples, the IoT devices may be communicatively connected to a communication system with network slicing capabilities to assist in the determination of the IoT devices connected to the network. For example, the communication system may include one or more network access nodes (e.g., base stations or a gNodeB). The network access nodes may use, in some examples, New Radio (NR) technology with radios featuring Software Defined Radio (SDR) with various Multiple Input Multiple Output (MIMO) options. The communication system may include a plurality of Network Functions (NFs) for managing subscription, authentication, access, routing, packet gateway control, etc. that form radio and network connections. The IoT devices may form uplink and/or downlink connections for transmittal and/or receival of data, respectively. In some examples, an uplink connection may include an uplink registration. In some examples, an IoT device may perform an attach and/or a registration procedure with/without a Packet Data Network (PDN) connection. Thus, during an uplink operation, a device may first complete a registration procedure before communicating actual data. In some examples, a device may have to perform this registration procedure to communicate data after exiting a power saving mode or an idle mode.

Hardware processor 702 may execute instruction 708 to determine a configuration setting of the IoT devices associated with a first energy consumption value. For example, the configuration setting may be an operational parameter corresponding to the IoT device.

Operational parameter records may include data corresponding to an uplink/downlink timer, standby timer, paging timer, etc. The plurality of IoT devices may each communicate data, by attaching metadata to it, for describing a data type during an uplink operation. Further, IoT application(s) deployed on an IoT platform may communicate downlink data with the M-IoT devices. Further, the instructions may be executable by the processor to obtain these operational parameter records with which the plurality of IoT devices may be currently configured

In some examples, the operational parameters may refer to various operational states of a device over a network. These operational states can be an uplink/downlink state, an idle state, a power saving state, etc. The uplink denoted as “UL” may refer to a process of sending data from a device to an IoT platform/application. The downlink denoted as “DL” may refer to a process of sending data from an IoT platform/application to a device. In some examples discussed herein, uplink and downlink operations may be performed via a communication system. In some examples, in an idle state, a device may be in a partial power saving state as it allows only downlink. Uplink operations may be suspended in an idle state. A power saving mode/state can be a deep sleep state, where a device may be registered on a network but may not allow uplink and downlink operations.

In some examples, the configuration settings of devices may be determined based at least in part on timer values of the device. For example, an IoT device may consume “x” amount of power for each uplink operation, “y” amount of power for each downlink operation, “z” amount of power during standby operation, etc. A cumulative (x+y+z . . . ) of power consumed for these operations may be used to estimate overall consumption. In some examples, a subset of the IoT devices out of the plurality of IoT devices may exhibit different patterns of operational parameters and correlate the differences in configuration settings with the source of the differences in operational parameters. For example, certain devices within a cluster may exhibit frequent uplink and/or downlink states, which may cause higher power consumption when compared to other devices within the same cluster.

Hardware processor 702 may execute instruction 710 to determine, using an ML model, a first adjustment value to the configuration setting. For example, the identification of a subset of IoT devices, configuration settings of the IoT devices, and candidate configuration settings may be transmitted to a reconfiguration system associated with processor 702 to implement an iterative and continuous configuration process that determines a more optimal configuration of the IoT devices. In some examples, the reconfiguration process is automated and autonomous.

The first adjustment value to the configuration setting may be determined through an iterative process that determines which configuration settings yield the most reward. For example, an agent may be operated during a machine learning process (e.g., reinforcement learning) to determine the optimal configuration for the IoT device. The agent provides the adjustment value to reconfigure the configuration setting at the IoT device and receives feedback in the form of rewards or penalties. The agent, through the machine learning process, may determine a next/second adjustment value to try to maximize cumulative rewards over time.

Hardware processor 702 may execute instruction 712 to apply the first adjustment value that causes the IoT device to be associated with a second energy consumption value. For example, the agent may determine the first adjustment value to apply to the IoT device, which yields an immediate reward and also a subsequent reward in the reinforcement learning context. Each time the agent changes the configuration setting of the device by the adjustment value, the system receives feedback from the IoT device.

In some examples, the feedback to the agent during the machine learning process may be received as log files. Using the log files, the system can determine the current energy consumption of the device and hence the associated battery life. Over a sequence of interactions of the agent with the IoT device, the high-level objective will be to observe a decreasing trend in the energy consumption, which in turn corresponds to an improving, or increasing, trend in the battery lifetime.

Hardware processor 702 may execute instruction 714 to determine a second adjustment value to the configuration setting. For example, when the second energy consumption value is greater than the first energy consumption value, the processor may determine the second adjustment value using an ML model.

In some examples, the change in energy consumption is determined over a particular time period. For example, let E(t) represent the energy consumed by an IoT device in the previous time period, that is between t and (t−1). Similarly, E(t−1) represents the energy consumed during the time period (t−1) and (t−2) prior to time period t. Let EC(t) denote the percentage change in energy consumption during a particular period of time t.

$$EC ( t ) = ( E ( t ) - E ( t - 1 ) ) / E ( t - 1 ) \qquad ( 1 )$$

Then the improvement in energy consumption can be assigned a score as follows, which identifies the improvement as energy is reduced:

$$s ( t ) = - 1 if EC > 0 : s ( t ) = 0 if EC = 0 ; s ( t ) = 1 if EC < 0 \qquad ( 2 )$$

A negative score implies that the most recent configuration changes are not improving battery consumption or reducing energy consumption. A medium to high positive score implies that the most recent configuration changes are taking us towards the long-term objective of improving battery lifetime or reducing energy consumption.

The reward function of the machine learning process may correspond with a numerical signal provided by the IoT device to indicate the immediate benefit or cost associated with the agent's adjustment to the configuration setting, in this case, the reward function is defined as reward (t)=s (t). The goal of the agent is to maximize cumulative rewards over time.

Hardware processor 702 may execute instruction 716 to apply the second adjustment value to the IoT device. For example, the IoT device may be reconfigured with power saving timers/active timers using device management and service enablement protocols, such as Open Mobile Alliance Lightweight Machine to Machine (OMA LwM2M) protocol over a Constrained Application Protocol (CoAP) transport. In some communication systems, due to certain network conditions, such as poor signal strength, high network traffic, interference(s), or the like, the network can be unstable and/or experience low throughput. CoAP may be a specialized web transfer lightweight and compact protocol operable over unstable and/or low-throughput networks for use with constrained devices/networks. It may be used for Machine-to-Machine (M2M) applications such as smart devices, building automation, or the like. In some examples, CoAP may comply with Internet Engineering Task Force (IETF) RFC 7252 specification.

In some examples, reconfiguration of power saving timers may be performed via network exposure functions. The reconfiguration may apply the determined adjustment value to the configuration setting. This enables the plurality of IoT devices to establish uplinks and be available for downlinks for optimal data transfer, energy consumption, and battery life.

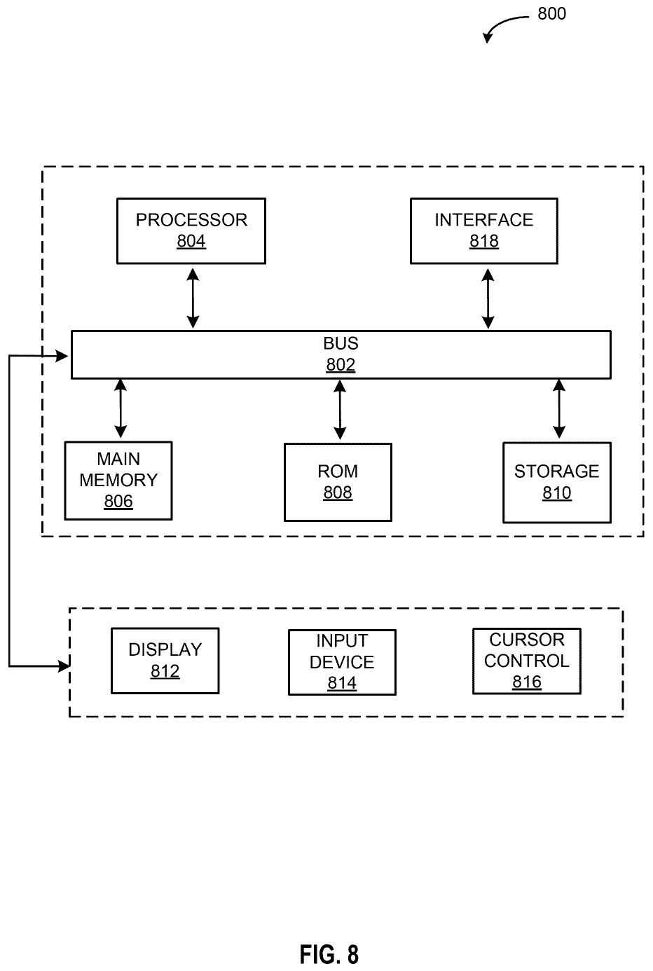

FIG. 8 depicts a block diagram of an example computer system 800 in which various of the examples described herein may be implemented. The computer system 800 includes a bus 802 or other communication mechanism for communicating information, one or more hardware processors 804 coupled with bus 802 for processing information. Hardware processor(s) 804 may be, for example, one or more general purpose microprocessors.

The computer system 800 also includes a main memory 806, such as a random access memory (RAM), cache and/or other dynamic storage devices, coupled to bus 802 for storing information and instructions to be executed by processor 804, including instructions to measure energy consumption or determine adjustment values of the IoT devices. Main memory 806 also may be used for storing temporary variables or other intermediate information during execution of instructions to be executed by processor 804. Such instructions, when stored in storage media accessible to processor 804, render computer system 800 into a special-purpose machine that is customized to perform the operations specified in the instructions.

The computer system 800 further includes a read only memory (ROM) 808 or other static storage device coupled to bus 802 for storing static information and instructions for processor 804. A storage device 810, such as a magnetic disk, optical disk, or USB thumb drive (Flash drive), etc., is provided and coupled to bus 802 for storing information and instructions.

The computer system 800 may be coupled via bus 802 to a display 812, such as a liquid crystal display (LCD) (or touch screen), for displaying information to a computer user. An input device 814, including alphanumeric and other keys, is coupled to bus 802 for communicating information and command selections to processor 804. Another type of user input device is cursor control 816, such as a mouse, a trackball, or cursor direction keys for communicating direction information and command selections to processor 804 and for controlling cursor movement on display 812. In some examples, the same direction information and command selections as cursor control may be implemented via receiving touches on a touch screen without a cursor.

The computing system 800 may include a user interface module to implement a GUI that may be stored in a mass storage device as executable software codes that are executed by the computing device(s). This and other modules may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

In general, the word “component,” “engine,” “system,” “database,” data store,” and the like, as used herein, can refer to logic embodied in hardware or firmware, or to a collection of software instructions, possibly having entry and exit points, written in a programming language, such as, for example, Java, C or C++. A software component may be compiled and linked into an executable program, installed in a dynamic link library, or may be written in an interpreted programming language such as, for example, BASIC, Perl, or Python. It will be appreciated that software components may be callable from other components or from themselves, and/or may be invoked in response to detected events or interrupts. Software components configured for execution on computing devices may be provided on a computer readable medium, such as a compact disc, digital video disc, flash drive, magnetic disc, or any other tangible medium, or as a digital download (and may be originally stored in a compressed or installable format that requires installation, decompression or decryption prior to execution). Such software code may be stored, partially or fully, on a memory device of the executing computing device, for execution by the computing device. Software instructions may be embedded in firmware, such as an EPROM. It will be further appreciated that hardware components may be comprised of connected logic units, such as gates and flip-flops, and/or may be comprised of programmable units, such as programmable gate arrays or processors.

The computer system 800 may implement the techniques described herein using customized hard-wired logic, one or more ASICs or FPGAS, firmware and/or program logic which in combination with the computer system causes or programs computer system 800 to be a special-purpose machine. According to one example, the techniques herein are performed by computer system 800 in response to processor(s) 804 executing one or more sequences of one or more instructions contained in main memory 806. Such instructions may be read into main memory 806 from another storage medium, such as storage device 810. Execution of the sequences of instructions contained in main memory 806 causes processor(s) 804 to perform the process steps described herein. In alternative examples, hard-wired circuitry may be used in place of or in combination with software instructions.

The term “non-transitory media,” and similar terms, as used herein refers to any media that store data and/or instructions that cause a machine to operate in a specific fashion. Such non-transitory media may comprise non-volatile media and/or volatile media. Non-volatile media includes, for example, optical or magnetic disks, such as storage device 810. Volatile media includes dynamic memory, such as main memory 806. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, and networked versions of the same.

Non-transitory media is distinct from but may be used in conjunction with transmission media. Transmission media participates in transferring information between non-transitory media. For example, transmission media includes coaxial cables, copper wire and fiber optics, including the wires that comprise bus 802. Transmission media can also take the form of acoustic or light waves, such as those generated during radio-wave and infra-red data communications.

The computer system 800 also includes interface 818 coupled to bus 802. Interface 818 provides a two-way data communication coupling to one or more network links that are connected to one or more local networks. For example, interface 818 may be an integrated services digital network (ISDN) card, cable modem, satellite modem, or a modem to provide a data communication connection to a corresponding type of telephone line. As another example, interface 818 may be a local area network (LAN) card to provide a data communication connection to a compatible LAN (or WAN component to communicated with a WAN). Wireless links may also be implemented. In any such implementation, interface 818 sends and receives electrical, electromagnetic or optical signals that carry digital data streams representing various types of information.

A network link typically provides data communication through one or more networks to other data devices. For example, a network link may provide a connection through local network to a host computer or to data equipment operated by an Internet Service Provider (ISP). The ISP in turn provides data communication services through the world wide packet data communication network now commonly referred to as the “Internet.” Local network and Internet both use electrical, electromagnetic or optical signals that carry digital data streams. The signals through the various networks and the signals on network link and through interface 818, which carry the digital data to and from computer system 800, are example forms of transmission media.

The computer system 800 can send messages and receive data, including program code, through the network(s), network link and interface 818. In the Internet example, a server might transmit a requested code for an application program through the Internet, the ISP, the local network and interface 818.

The received code may be executed by processor 804 as it is received, and/or stored in storage device 810, or other non-volatile storage for later execution.

Each of the processes, methods, and algorithms described in the preceding sections may be embodied in, and fully or partially automated by, code components executed by one or more computer systems or computer processors comprising computer hardware. The one or more computer systems or computer processors may also operate to support performance of the relevant operations in a “cloud computing” environment or as a “software as a service” (SaaS). The processes and algorithms may be implemented partially or wholly in application-specific circuitry. The various features and processes described above may be used independently of one another, or may be combined in various ways. Different combinations and sub-combinations are intended to fall within the scope of this disclosure, and certain method or process blocks may be omitted in some implementations. The methods and processes described herein are also not limited to any particular sequence, and the blocks or states relating thereto can be performed in other sequences that are appropriate, or may be performed in parallel, or in some other manner. Blocks or states may be added to or removed from the disclosed examples. The performance of certain of the operations or processes may be distributed among computer systems or computers processors, not only residing within a single machine, but deployed across a number of machines.

As used herein, a circuit might be implemented utilizing any form of hardware, software, or a combination thereof. For example, one or more processors, controllers, ASICs, PLAs, PALs, CPLDs, FPGAs, logical components, software routines or other mechanisms might be implemented to make up a circuit. In implementation, the various circuits described herein might be implemented as discrete circuits or the functions and features described can be shared in part or in total among one or more circuits. Even though various features or elements of functionality may be individually described or claimed as separate circuits, these features and functionality can be shared among one or more common circuits, and such description shall not require or imply that separate circuits are required to implement such features or functionality. Where a circuit is implemented in whole or in part using software, such software can be implemented to operate with a computing or processing system capable of carrying out the functionality described with respect thereto, such as computer system 800.

As used herein, the term “or” may be construed in either an inclusive or exclusive sense. Moreover, the description of resources, operations, or structures in the singular shall not be read to exclude the plural. Conditional language, such as, among others, “can,” “could,” “might,” or “may,” unless specifically stated otherwise, or otherwise understood within the context as used, is generally intended to convey that certain examples include, while other examples do not include, certain features, elements and/or steps.

Terms and phrases used in this document, and variations thereof, unless otherwise expressly stated, should be construed as open ended as opposed to limiting. Adjectives such as “conventional,” “traditional,” “normal,” “standard,” “known,” and terms of similar meaning should not be construed as limiting the item described to a given time period or to an item available as of a given time, but instead should be read to encompass conventional, traditional, normal, or standard technologies that may be available or known now or at any time in the future. The presence of broadening words and phrases such as “one or more,” “at least,” “but not limited to” or other like phrases in some instances shall not be read to mean that the narrower case is intended or required in instances where such broadening phrases may be absent.

What is claimed is:

1. A system comprising:
a processor; and
a machine-readable storage medium comprising instructions, the instructions executable by the processor that cause the processor to:
determine a subset of Internet of Things (IoT) devices of a plurality of IoT devices that are connected to a network;
determine a configuration setting of the subset of IoT devices that is shared amongst the subset of IoT devices, and that is associated with a first energy consumption value;
apply a first adjustment value to the configuration setting of the subset of IoT devices that causes the subset of IoT devices to be associated with a second energy consumption value, the first adjustment value being determined using a machine learning (ML) model;
when the second energy consumption value is greater than the first energy consumption value, determine, using the ML model, a second adjustment value to the configuration setting of the subset of IoT devices; and
apply the second adjustment value to the configuration setting of the subset of IoT devices.

2. The system of claim 1, wherein the processor is further caused to:
determine, using the ML model, a third adjustment value to the configuration setting of the subset of IoT devices that causes the subset of IoT devices to be associated with a third energy consumption value; and
when the third energy consumption value is less than the first energy consumption value, reverse a configuration update to the subset of IoT devices and apply a second adjustment value to the subset of IoT devices.

3. The system of claim 1, wherein the subset of IoT devices are related by communication messages transmitted or received by the subset of IoT devices and are stored in a log file.

4. The system of claim 1, wherein the configuration setting are determined and the second adjustment value are applied to the configuration setting during an energy consumption process.

5. The system of claim 1, wherein the subset of IoT devices are identified using device identifiers for the subset of IoT devices that are identified in a log file between the plurality of IoT devices.

6. The system of claim 1, wherein the configuration setting of the subset of IoT devices is related to a Power Cost Function (PCF), and the first adjustment value adjusts the Power Cost Function (PCF).

7. The system of claim 1, wherein the processor is further caused to:
select a second subset of IoT devices of the plurality of IoT devices; and
initiate the energy consumption process for the second subset of IoT devices of the plurality of IoT devices.

8. The system of claim 1, wherein adjusting the configuration setting is implemented by a controller in a 5G core portion of the system.

9. The system of claim 1, wherein the subset of IoT devices are a common device type.

10. A computer-implemented method comprising:
determining a subset of Internet of Things (IoT) devices of a plurality of IoT devices that are connected to a network;
determining a configuration setting of the subset of IoT devices that is shared amongst the subset of IoT devices, and that is associated with a first energy consumption value;
applying a first adjustment value to the configuration setting of the subset of IoT devices that causes the subset of IoT devices to be associated with a second energy consumption value, the first adjustment value being determined using a machine learning (ML) model;
when the second energy consumption value is greater than the first energy consumption value, determining, using the ML model, a second adjustment value to the configuration setting of the subset of IoT devices; and
applying the second adjustment value to the configuration setting of the subset of IoT devices.

11. The computer-implemented method of claim 10, further comprising:
determining, using the ML model, a third adjustment value to the configuration setting of the subset of IoT devices that causes the subset of IoT devices to be associated with a third energy consumption value; and
when the third energy consumption value is less than the first energy consumption value, reversing a configuration update to the subset of IoT devices and apply a second adjustment value to the subset of IoT devices.

12. The computer-implemented method of claim 10, wherein the subset of IoT devices are related by communication messages transmitted or received by the subset of IoT devices and are stored in a log file.

13. The computer-implemented method of claim 10, wherein the configuration setting are determined and the second adjustment value are applied to the configuration setting during an energy consumption process.

14. The computer-implemented method of claim 10, wherein the subset of IoT devices are identified using device identifiers for the subset of IoT devices that are identified in a log file between the plurality of IoT devices.

15. The computer-implemented method of claim 10, wherein the configuration setting of the subset of IoT devices is related to a Power Cost Function (PCF), and the first adjustment value adjusts the Power Cost Function (PCF).

16. The computer-implemented method of claim 10, further comprising:
select a second subset of IoT devices of the plurality of IoT devices; and
initiate the energy consumption process for the second subset of IoT devices of the plurality of IoT devices.

17. The computer-implemented method of claim 10, wherein adjusting the configuration setting is implemented by a controller in a 5G core portion of the system.

18. The computer-implemented method of claim 10, wherein the subset of IoT devices are a common device type.

19. A non-transitory computer-readable storage medium storing a plurality of instructions executable by a processor, the plurality of instructions when executed by the processor cause the processor to:
determine a subset of Internet of Things (IoT) devices of a plurality of IoT devices that are connected to a network;
determine a configuration setting of the subset of IoT devices that is shared amongst the subset of IoT devices, and that is associated with a first energy consumption value;
apply a first adjustment value to the configuration setting of the subset of IoT devices that causes the subset of IoT devices to be associated with a second energy consumption value, the first adjustment value being determined using a machine learning (ML) model;
when the second energy consumption value is greater than the first energy consumption value, determine, using the ML model, a second adjustment value to the configuration setting of the subset of IoT devices; and
apply the second adjustment value to the configuration setting of the subset of IoT devices.

20. The non-transitory computer-readable storage medium of claim 19, wherein the processor is further caused to:
determine, using the ML model, a third adjustment value to the configuration setting of the subset of IoT devices that causes the subset of IoT devices to be associated with a third energy consumption value; and
when the third energy consumption value is less than the first energy consumption value, reverse a configuration update to the subset of IoT devices and apply a second adjustment value to the subset of IoT devices.
